(19) United States
(12) Patent Application Publication
(10) Pub. No.: US 2016/0056659 A1
(43) Pub. Date: Feb. 25, 2016

(54) WATERPROOF WIRELESS KEYBOARD WITH WIRELESS CHARGING FUNCTION

(71) Applicant: i-Money Technology Co., Ltd., Taipei City (TW)

(72) Inventor: Yu-Chung MA, Taipei City (TW)

(21) Appl. No.: 14/515,159

(22) Filed: Oct. 15, 2014

(30) Foreign Application Priority Data
Aug. 20, 2014 (TW) 103214887

(51) Int. Cl. H02J 7/02; G06F 3/023; G06F 3/041; H02J 7/00

(52) U.S. Cl. CPC H02J 7/025; H02J 7/0042; G06F 3/0231; G06F 3/041

(57) ABSTRACT

The present invention provides a waterproof wireless keyboard with wireless charging function, comprising: a wireless keyboard set, including a keyboard module having a plurality of key-inputting cells, a wireless communication module connected to the keyboard module to output corresponding commands of the key-inputting cells, and a wireless charging receiver module connected to and powers the keyboard module; and a hermetic case, including a first housing and a second housing that sandwich the wireless keyboard set therebetween, the first housing having a key-inputting portion corresponding to the key-inputting cells, the first housing being peripherally provided with a first seal structure, and the second housing being peripherally provided with a second seal. structure that matches and engages with the first seal structure.

### BACKGROUND OF THE INVENTION

1. Technical Field

The present invention relates to waterproof keyboards, and more particularly to a waterproof wireless keyboard with wireless charging function

2. Description of Related Art

With the advent of era of technology, electronic computers have almost taken the place of mechanical computers, and are now popular in offices and homes around the world. In fact, personal computers have shown significant progress recently. If time and storage capacity were not limitations, the modern personal computers could even perform as former super computers.

The modern electronic computers are equipped with various input devices, such as mice, keyboards, trace balls, etc. Taking a keyboard for example, a keyboard represents a series of keys connected to a computer for entering corresponding commands to the software systems in the computer. According to the numbers of keys thereon, keyboards are classified into different types (e.g. 101-key keyboards, 104-key keyboards, and more). By operating keyboards, entry of corresponding characters and control of computer operations can be achieved. While wired keyboards once dominated the market, the emergence of technologies such as wireless 2.4 Ghz RF and Bluetooth, wireless peripherals are now prevailing.

While some existing wired and wireless keyboards have spill-resistant designs, they are not really resistant to water. For example, Taiwan Patent No. 1313017 discloses a keyboard having an escape canal, which allows water spilled over the keyboard to be guided by a waterproof film to the escape canal and discharged out. However, such a prior-art keyboard is limited in its spill-resistant capacity. In the event that the water spilled over it is in a large amount, the water and the moisture can still invade into the interior of the keyboard through the intervals between the key caps. China Patent No. 201910030, on the other hand, discloses a wired waterproof keyboard, which provides spill resistance by wrapping the body of the keyboard by a protective cover. Since the keyboard needs to be connected to a computer through a physical cable, the moisture can still invade the interior of the keyboard through the gap between the cable and the cover. When assessed to the military standards, the so-called waterproof keyboard is not really water resistant.

### SUMMARY OF THE INVENTION

The purpose of the invention is to solve the problem that the wireless keyboard cannot achieve water resistant ability because of the charging hole or the battery cover.

In order to achieve the above purpose, the present invention provides a waterproof wireless keyboard with wireless charging function, comprising: a wireless keyboard set, including a keyboard module having a plurality of key-inputting cells, a Wireless communication module connected to the keyboard module to output corresponding commands of the key-inputting cells, and a wireless charging receiver module connected to and powers the keyboard module; and a hermetic ease, including a first housing and a second housing that sandwich the wireless keyboard set therebetween, the first housing having a key-inputting portion corresponding to the key-inputting cells, the first housing being peripherally provided with a first seal structure, and the second housing being peripherally provided with a second seal structure that matches and engages with the first seal structure.

Preferably, the first seal structure is a peripheral rib formed on the first housing, and the second seal structure is a peripheral groove formed on the second housing for fittingly receiving the peripheral rib, while a water-repellent glue is provided between the peripheral rib and the peripheral groove.

Preferably, the first seal structure is a peripheral groove formed on the first housing, and the second seal structure is a peripheral rib formed on the second housing for being fittingly received in the peripheral groove, while a water-repellent glue is provided between the peripheral rib and the peripheral groove.

Preferably, each of the first housing and the second housing is made of a material selected from rubber, silica gel and synthetic plastic.

Preferably, the keyboard module is a printed circuit board having a control unit, and the key-inputting cells are metal inductive points provided on the printed circuit board.

Preferably, the key-inputting portion includes a plurality of keys each corresponding to one said key-inputting cell, and a plurality of conductive members provided at inner surfaces of the keys.

Preferably, the inner surface of each said key is provided with at least four said conductive members at four corners thereof.

Preferably, the waterproof wireless further comprises a wireless charging transmitter connected to an electronic device or an external power source, wherein the wireless charging transmitter is in inductive coupling with the wireless charging receiver module.

Preferably, the wireless charging receiver module comprises a rechargeable battery, an induction coil for receiving energy generated by the inductive coupling, and a charging circuit that is connected to the induction coil and the rechargeable battery so as to charge the rechargeable battery.

Preferably, the second housing has a socket at a surface thereof reverse to the wireless keyboard set for receiving the wireless charging transmitter, and the induction coil is deposited on a surface of the second housing reverse to the socket.

Preferably, the second housing comprises a first recessed structure for receiving the keyboard module, and a second recessed structure for receiving the wireless charging receiver module.

Preferably, the waterproof wireless keyboard further comprises a wireless communication device connected to an electronic device, wherein the wireless communication device is connected to the wireless communication module through wireless transmission for receiving the corresponding commands of the key-inputting cells,

Preferably, the waterproof wireless keyboard further comprises a touch panel module connected to the wireless communication module, and a touch operation portion that is provided on the first housing and corresponding to the touch panel module.

Therefore, compared to the keyboard of the prior art, the present invention has following advantages: 1. the completely sealing effect is achieve through the hermetic case completely seals the wireless keyboard and the first housing and the second housing that sandwich the wireless keyboard set therebetween; 2. the wireless keyboard is connected to electronic device via wireless communication module, and is charged by wireless charging transmission device (corresponding to wireless charging receiver module); thus, there is no external cables in the wireless keyboard and no needs to changing the battery of the wireless keyboard of the present invention so that the problem of water invasion from the gap between the cable and the cover to the interior of the keyboard can be avoided.

### BRIEF DESCRIPTION OF THE DRAWINGS

FIG. 1 is a schematic drawing illustrating a waterproof wireless keyboard with wireless charging function according to the present invention.

FIG. 2 and FIG. 3 are exploded views of the waterproof wireless keyboard with wireless charging function according to the present invention.

FIG. 4 and FIG. 5 are partial, enlarged view of the waterproof wireless keyboard with wireless charging function according to the present invention.

FIG. 6 is a schematic drawing illustrating the combination of a first seal structure and a second seal structure according to the present invention.

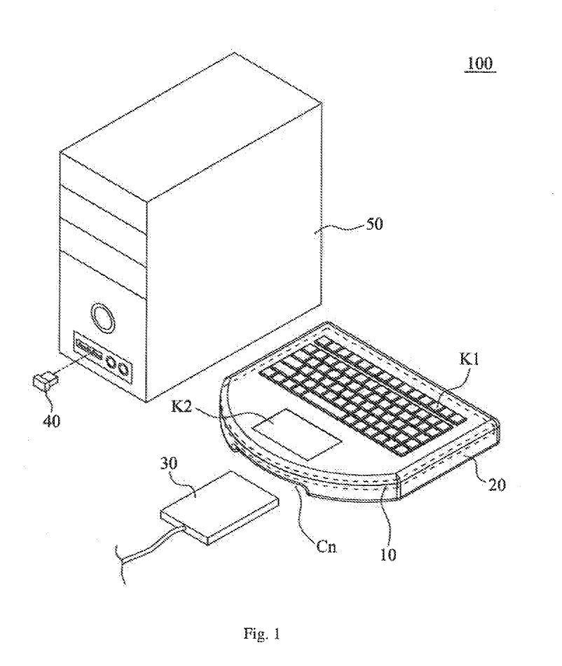

### DETAILED DESCRIPTION OF THE INVENTION

The present invention is now explained with reference to the accompanying drawings,

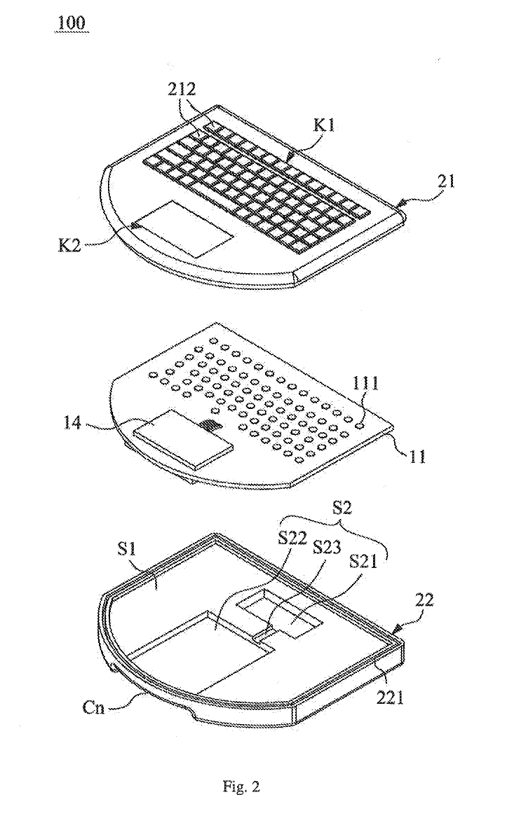

According to the present invention, a waterproof wireless keyboard with wireless charging function 100 comprises primarily a wireless keyboard set 10 and a hermetic case 20 wrapping the wireless keyboard set 10 from outside, The wireless keyboard set 10 is in wireless communication with an electronic device 50 (e.g. a host computer) and acts as an input device for the electronic device 50. A wireless communication device 40 is provided on the electronic device 50 for allowing wireless connection between the electronic device 50 and the wireless keyboard set 10, so that the electronic device 50 can receive the commands entered through the wireless keyboard set 10. Corresponding to the wireless keyboard set 10, a wireless charging transmitter 30 (Transmitter, TX) is provided. The wireless charging transmitter 30 may be connected to and thereby powered by an external power source or the electronic device 50, and uses the principle of inductive coupling to transmit power wirelessly to an induction coil 132 (Receiver, RX) installed in the wireless keyboard set 10 (as shown in FIG. 2), thereby powering the wireless keyboard set 10 by means of wireless transmission. With the foregoing configuration, there is no need for the hermetic case 20 to have any openings that allow power cords and transmission cables to pass. The wireless keyboard set 10 can communicate wirelessly with the electronic device 50 and the wireless charging transmitter 30.

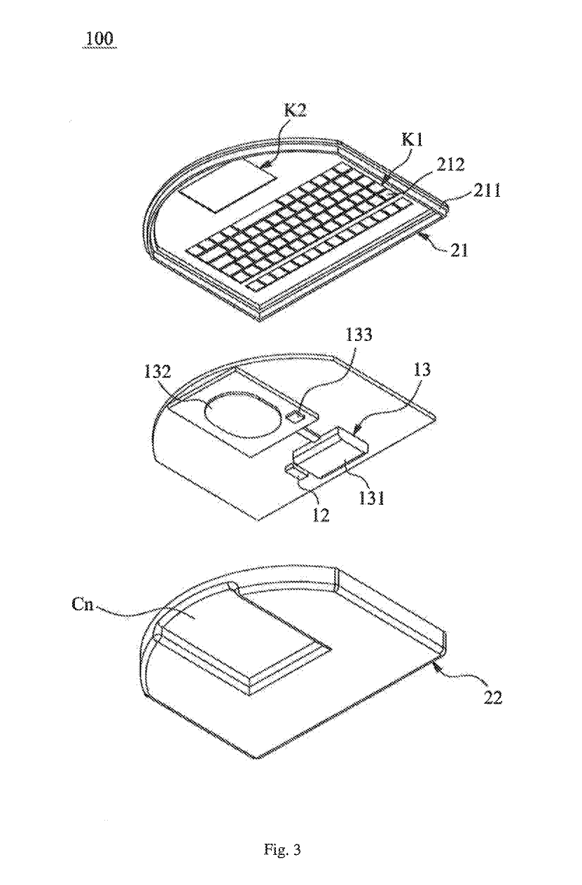

Now please refer to FIG. 2 and FIG. 3 for exploded views of the waterproof wireless keyboard 10.

As shown, in the present embodiment, the wireless keyboard set 10 comprises a keyboard module 11 having a plurality of key-inputting cells 111, a touch panel module 14, a wireless communication module 12 that is connected to the keyboard module 11 and the touch panel module 14 so as to output the corresponding commands of the key-inputting cell ill of the touch panel module 14), and a wireless charging receiver module 13 that is connected to the keyboard module 11 and the touch panel module 14 and provides power required by the wireless keyboard set 10.

The keyboard module 11 is a printed circuit board having a control unit (not shown). The plurality of key-inputting cells 111 are metal inductive points deposited on the printed circuit board. When finding that one or more of the metal inductive points are triggered, the control unit generates the corresponding operating signals.

The wireless communication module 12 Is preferably a Bluetooth communication module. However, the wireless communication module 12 may be alternatively realized using other wireless technologies, such as wireless LAN (WLAN), Zigbee, radio frequency identification (RFID) and near field communication (NFC), without limitation.

The wireless charging receiver module 13 comprises a rechargeable battery 131, an induction coil 132 that receives the energy generated by the inductive coupling, and a charging circuit 133 that is connected to the induction coil 132 and the rechargeable battery 131 for charging the rechargeable battery 131. The charging circuit 133 may be a rectifier circuit, a filter or an amplifier, for stabilizing, rectifying, noise-filtering or stepping-down the induced current obtained by the induction coil 132 during inductive coupling.

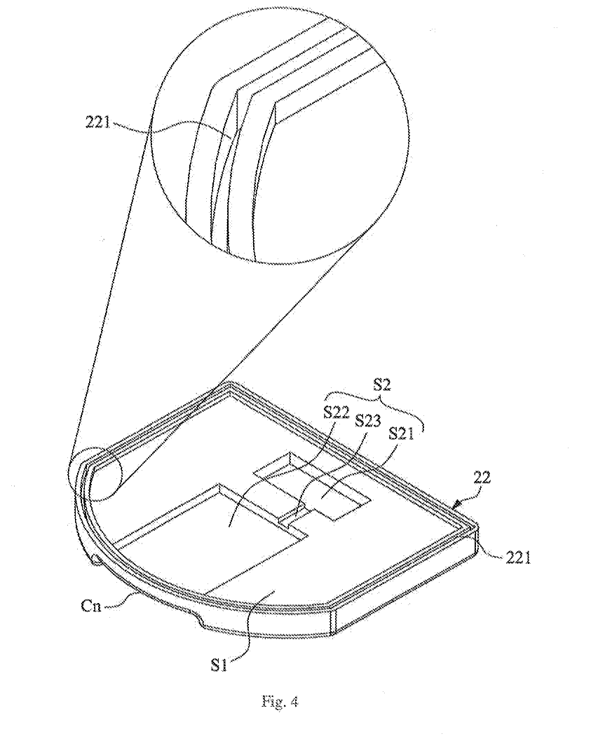

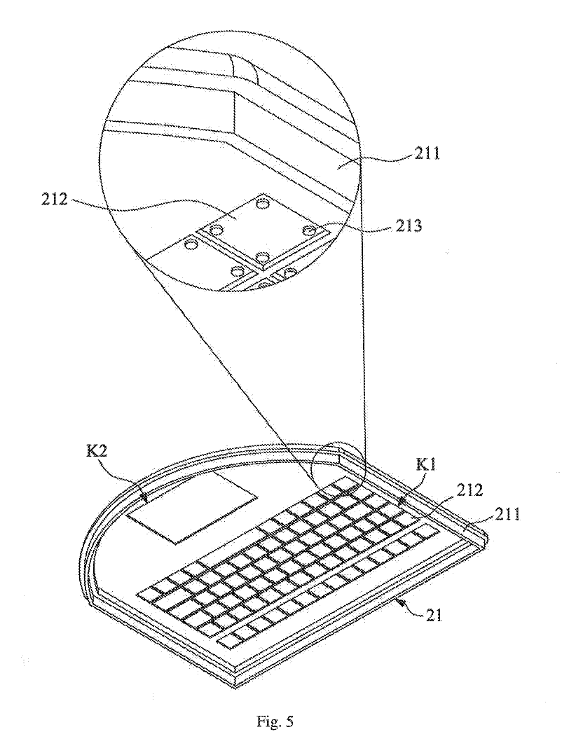

Please further refer to FIG. 4 and FIG. 5. The hermetic case 20 includes a first housing 21 and a second housing 22 that sandwich the wireless keyboard set 10 therebetween.

A socket Cn is formed at a bottom of the second housing 22 for receiving the wireless charging transmitter 30. The induction coil 132 is deposited on the second housing 22 at the reverse side of the socket Cn (i.e. on the surface of the second housing 22 facing inward), so as to be corresponding to the wireless charging transmitter 30. The second housing 22 at the side reverse to the socket Cn has a first recessed structure Si and a. second recessed structure S2. The first recessed structure S1 is shaped according to the profile of the keyboard module 11, so as to fittingly receive the keyboard module 11 therein and make the keyboard module 11 fixed on the second housing 22. The second recessed structure S2 is formed on the first recessed structure S1, for receiving the wireless charging receiver module 13. The second recessed structure S2 comprises a first accommodating space S21 for receiving the rechargeable battery 131, a second accommodating space S22 for receiving the induction coil 132, and a cable duct S23 for receiving cables connecting the rechargeable battery 131 and the induction coil 132. In an embodiment not shown, additional sockets may be provided for receiving the printed circuit board and the wireless communication module.

The first housing 21 and the second housing 22 may each be made of silica gel, rubber, synthetic plastic or other materials that are properly elastic and facilitate sealing, without limitation, The first housing 21 is provided with a key-inputting portion K1 corresponding to each of the key-inputting cells 111, and a touch operation portion K2 corresponding to the touch panel module 14. The key-inputting portion K1 acts as the key caps of a conventional keyboard, with its key stroke determined its intrinsic elasticity, its structure, or additional elastic elements or spring mechanisms. The key-inputting portion K1 comprises a plurality of keys 212 each corresponding to one of the key-inputting cells 111, and a plurality of conductive members 213 provide at the inside of the keys 212. Each of the keys 212 has its inner surface provided with at least four conductive members 213 each at one of the four corners of the key. When a key 212 is pressed, the conductive members 213 of the key 212 become connected to the corresponding key-inputting cell 111, so as to trigger the corresponding command.

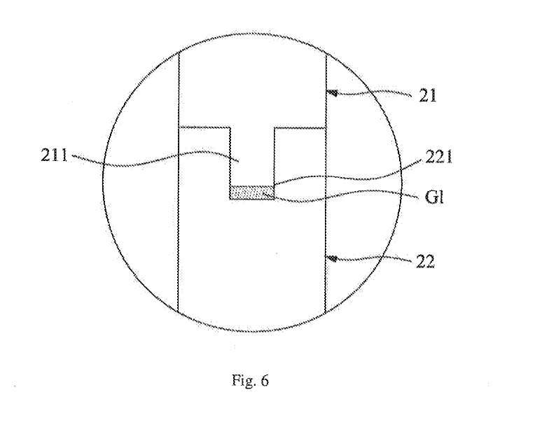

Now please refer to FIG. 6 wherein the combination between a first seal structure and a second seal structure of the present invention is illustrated.

As shown, the first housing 21 is peripherally provided with a first seal structure 211, and the second housing 22 is peripherally provided with a second seal structure 221 that is configured to match and engage with the first seal structure 211. In the present embodiment, the first seal structure 211 is a peripheral rib of the first housing 21, and the second seal structure 221 is a peripheral groove of the second housing 22 for fittingly receiving the rib. For preventing moisture from entering through the interval between the rib and the groove, a water-repellent glue G1 is provided or filled between the rib and the groove. As an alternative scheme of the present invention, the first seal structure 211 is a groove and the second seal structure 221 is a rib. In addition, all the equivalents of the combination of the groove and the rib, including a combination of plural grooves and plural ribs, are regarded as falling into to scope of the present invention.

To sum up, with the provision of the hermetic case, the wireless keyboard set is well protected, while the waterproof structure fully seals any potential intervals between the first housing and the second housing, so as to achieve full seal. By using the wireless communication module to provide wireless connection with the electronic device, and using the wireless charging transmitter (corresponding to the wireless charging receiver module) to wirelessly power the keyboard, the disclosed keyboard eliminates the need for physical cables, thereby solving the prior-art devices' problem that moisture may invade the interior of the keyboard through the gap between the cable and the cover.

While example embodiments have been disclosed herein, it should be understood that other variations may be possible. Such variations are not to be regarded as a departure from the spirit and scope of example embodiments of the present application, and all such modifications as would be obvious to one skilled in the art are intended to he included within the scope of the following claims.

What is claimed is:

1. A waterproof wireless keyboard with wireless charging function, comprising:
a wireless keyboard set, including a keyboard module having a plurality of key-inputting cells, a wireless communication module connected to the keyboard module to output corresponding commands of the key-inputting cells, and a wireless charging receiver module connected to and powers the keyboard module; and
a hermetic case, including a first housing and a second housing that sandwich the wireless keyboard set therebetween, the first housing having a key-inputting portion corresponding to the key-inputting cells, the first housing being peripherally provided with a first seal structure, and the second housing being peripherally provided with a second seal structure that matches and engages with the first seal structure.

2. The waterproof wireless keyboard of claim 1, wherein the first seal structure is a peripheral rib formed on the first housing, and the second seal structure is a peripheral groove formed on the second housing for fittingly receiving the peripheral rib, while a water-repellent glue is provided between the peripheral rib and the peripheral groove.

3. The waterproof wireless keyboard of claim 1, wherein the first seal structure is a peripheral groove formed on the first housing, and the second seal structure is a peripheral rib formed on the second housing for being fittingly received in the peripheral groove, while a water-repellent glue is provided between the peripheral rib and the peripheral groove.

4. The waterproof wireless keyboard of claim 1, wherein each of the first housing and the second housing is made of a material selected from rubber, silica gel and synthetic plastic.

5. The waterproof wireless keyboard of any of claim 1, wherein the keyboard module is a printed circuit board having a control unit, and the key-inputting cells are metal inductive points provided on the printed circuit board.

6. The waterproof wireless keyboard of claim 5, wherein the key-inputting portion includes a plurality of keys each corresponding to one said key-inputting cell, and a plurality of conductive members provided at inner surfaces of the keys.

7. The waterproof wireless keyboard of claim 6, wherein the inner surface of each said key is provided with at least four said conductive members at four corners thereof.

8. The waterproof wireless keyboard of claim 1, further comprising a wireless charging transmitter connected to an electronic device or an external power source, wherein the wireless charging transmitter is in inductive coupling with the wireless charging receiver module.

9. The waterproof wireless keyboard of claim 8, wherein the wireless charging receiver module comprises a rechargeable battery, an induction coil for receiving energy generated by the inductive coupling, and a charging circuit that is connected to the induction coil and the rechargeable battery so as to charge the rechargeable battery.

10. The waterproof wireless keyboard of claim 9, wherein the second housing has a socket at a surface thereof reverse to the wireless keyboard set for receiving the wireless charging transmitter, and the induction coil is deposited on a surface of the second housing reverse to the socket.

11. The waterproof wireless keyboard of claim 1, wherein the second housing comprises a first recessed structure for receiving the keyboard module, and a second recessed structure for receiving the wireless charging receiver module.

12. The waterproof wireless keyboard of claim 1, further comprising a wireless communication device connected to an electronic device, wherein the wireless communication device is connected to the wireless communication module through wireless transmission for receiving the corresponding commands of the key-inputting cells.

13. The waterproof wireless keyboard of claim 1, further comprising a touch panel module connected to the wireless communication module, and a touch operation portion that is provided on the first housing and corresponding to the touch panel module.
